(19) United States
(12) Patent Application Publication
(10) Pub. No.: US 2008/0236515 A1
(43) Pub. Date: Oct. 2, 2008

(54) Dog training methods and apparatus

(76) Inventor: Lisa M. Carl, Watertown, NY (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/058,235

(22) Filed: Mar. 28, 2008

Related U.S. Application Data
(60) Provisional application No. 60/921,015, filed on Mar. 30, 2007.

(51) Int. Cl. A01K 15/02

(52) U.S. Cl. 119/753; 119/712

(57) ABSTRACT

A dog training device for use with a kennel can comprise a reflective surface manufactured from a plastic material and a supporting frame adapted to detachably attach to an exterior surface of a side wall of the kennel. The supporting frame can be configured to support the reflective surface so that said reflective surface faces the kennel. A device for covering a top wall of a kennel can comprise a flat sheet made of a durable sheet material and a peripheral ridge overhanging onto the top of a side wall of the kennel.

### CROSS REFERENCE TO RELATED APPLICATIONS

This application claims priority from U.S. Provisional Patent Application No. 60/921,015 entitled “Dog training methods and apparatus” filed on behalf of Carl, Lisa M., on Mar. 30, 2007.

### BACKGROUND OF THE INVENTION

The training of dogs is a considerably difficult and time-consuming undertaking. To that end, there are several existing problems relating to the care and training of dogs.

For example, it is known that dogs are voracious eaters and will literally consume all food put in front of them, without interruption, in a hurried manner when the food is presented to them. Resulting digestive problems have been noted as a result of rapid gulping of food. For example, possible consequences of such habits include Gastric Dilatation-Volvulus (GDV), gastritis, bloating, ulcers or other digestive-related disorder that could lead to injury or in some instance, require surgery. Therefore, there is a need to provide a system or apparatus that is designed to slow the consumption rate of pet feeding.

Another problem more closely associated with dog training is that of reliably and effectively diverting the dog's attention when needed, for example, when the dog is barking, or other unwanted activity, as needed, and to train the dog such that such activity does not occur or the occurrences of such activity is minimized.

Another problem relates to kenneling of the dogs. First, kenneling is often a traumatic experience for a dog, for example, that is accustomed to being around people or other dogs and is kenneled for the first time. The dog may experience separation anxiety, especially when left alone for long periods of time. There is a need to cure or minimize this problem.

Second, kennels are cage-like enclosures and therefore comprise a plurality of interstices through which items can either inadvertently or otherwise drop onto the interior and into contact with the dog. Moreover, the issue of kennels brings up a separate problem relating to the storage and more effective use thereof. That is to say, kennels, being cage-like in their appearance and relatively large and bulky, are not very well suited for use in homes and other structures or in areas in which space may be a premium. As a result, there are also needs relating to protecting the dog within the kennel, as well as being able to efficiently utilize kennels within an area.

### SUMMARY OF THE INVENTION

Therefore and according to one variation there is provided a training device for use by canines. The training device includes a tray member having a substantially flat planar supporting surface that is placed within a support frame. The support frame provides a base that stably supports the tray member, whose supporting surface is preferably elevated in relation to a ground surface, wherein the dog can more easily reach the food without having to bend or reach therefor. Moreover, food being disposed onto the raised tray reduces the incidence of gulping and therefore slows or reduces consumption rate.

According to one version, the support frame can be adjustably raised and lowered to different settings depending, for example, on the breed of dog. Alternatively, the frame can include pivoting elements to permit convenient storage thereof.

According to another aspect, there is provided a dog training device, said training device including an enclosed canister having an interior. A quantity of particulate or other material is disposed within the interior of the canister wherein agitation of the canister produces a loud and recognizable audible sound.

In one version, the canister is made from aluminum or other metal although plastic or other durable materials could be used. The canister is preferably entirely enclosed or can be resealed at one end wherein the contained material can include beads, stones or other loose particulates of common or varying types.

According to another variation, there is provided a cover for enclosing a portion of a kennel, said cover being defined by a continuous section of material that is placed in overlaying relation relative to a top portion of a kennel.

According to yet another variation, there is provided a device to prevent separation anxiety for a kenneled dog, the device comprising a frame that is connected to a side wall of the kennel frame and supporting a reflective or mirrored surface, said surface facing inwardly toward the interior of the kennel. The latter device reduces separation anxiety and calms the dog, keeping the dog occupied while reducing anxiety levels. This further minimizes the probability that the dog will act out by destroying valuable objects.

One advantage of the present invention is that aggressive dogs can be more effectively and efficiently trained, for example, by means of visual and aural stimulation from the above noted rattling device and kept from jumping or other unruly behavior.

Another advantage of the present invention is that dogs can be kenneled more effectively and with fewer hardships on the animal.

Yet still another advantage of the present invention is a reduction in gulping when a dog is consuming food, thereby reducing or at least minimizing the incidence of digestive disorders. The device also minimizes stress to the neck and back areas, while teaching slower eating habits.

These and other features and advantages will become apparent from the following Detailed Description, which should be read in conjunction with the accompanying drawings.

### BRIEF DESCRIPTION OF THE DRAWINGS

FIG. 1 is a perspective view of a device that is made in accordance with a first embodiment of the invention;

FIG. 2 is a perspective view of a dog kennel, including a device that is made in accordance with a second embodiment of the invention;

FIG. 3 is a partial view of the kennel of FIG. 2, including a that is device made in accordance with a third embodiment of the invention; and

FIG. 4 is a perspective view of a device made in accordance that is with a fourth embodiment of the invention.

### DETAILED DESCRIPTION

The following discussion relates to various devices used for dogs for the training of same and to assist in the training of dogs. It will be readily apparent that numerous variations and modifications are possible and that the following embodiments are merely exemplary in nature. In addition and throughout the discussion, several terms are used to provide a convenient frame of reference with regard to the accompanying drawings, such as “above”, “below”, “top”, “bottom” and the like. These terms, however, are not intended to be specifically limiting as to the invention, unless specifically indicated.

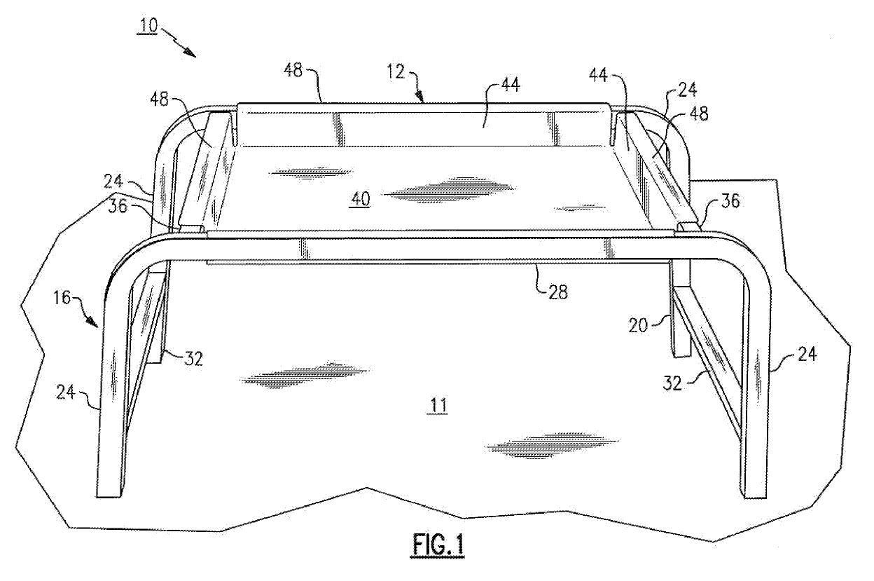

Referring to FIG. 1, there is shown a device 10 made in accordance with a first embodiment. The device 10 includes a tray member 12 that is fitted within a support frame 16. The support frame 16, according to this specific embodiment, consists of a set of tubular frame members 20, each frame member being defined by a pair of spaced vertical legs 24 and a horizontal connecting portion 28, defining a substantially inverted U-shaped configuration. The support frame according to this embodiment is made from stainless steel although other structural materials could easily be substituted. A pair of lateral supports 32 span each of the vertical legs 24 at an intermediate height thereof, the tray member 12 further including a pair of upper lateral supports 36. The upper lateral supports 36 and the horizontal connecting portions 28 of the support frame 16 combine to form a peripheral border for the tray member 12, wherein the latter is defined herein by a planar substantially flat sheet-like supporting surface 40 that is surrounded by a set of vertically extending side walls 44. The tray member 12 is fabricated from stainless steel according to this embodiment, although other durable non-corrodible materials could also be used. Alternatively, each of or both of the support frame 16 and the tray member 12 could also be manufactured or molded from a durable plastic material, such as, for example, a high density polyethylene.

Still referring to FIG. 1, a top flange 48 extends from the top of each vertically extending side wall 44 of the tray member 12, each flange extending substantially perpendicular in relation to the side wall and outwardly relative to the planar supporting surface 40. Each of the top flanges 48 are supported or seated upon the upper lateral supports 36 and the connecting horizontal sections 28 of the support frame 16 and thereby allow removable attachment of the tray member 12 from the herein described device 10, such as for cleaning or other purposes.

The vertical height of the planar supporting surface 40 of the supported tray member 12 according to this embodiment is approximately 8 inches above the ground surface 11, although this parameter can be suitably altered. In another version, the vertical legs 24 of the support frame 16 can be selectively adjusted, for example, using slots (not shown) in order to permit the tray member 12 to selectively assume different heights depending, for example, on the breed of dog, for example, between about 24-30 inches for larger dogs and between about 6-10 inches for small dogs. According to yet another embodiment, the vertical legs 24 can be pivotally mounted to permit storage of the device, when not in use.

In use, a quantity of food (not shown) is placed onto the planar supporting surface 40 of the tray member 12, as supported within the support frame 16, the latter serving as a stable base. As noted previously, the supporting surface 40 and therefore the food disposed thereupon is elevated with respect to a ground surface 11 in order to permit a dog (not shown) to eat therefrom without having the dog bend or extend downwardly, such as in the instance of a typical dog dish (not shown). As a result of the increased height, the dog is less likely to take in air along with food while eating. In addition and by having food dispersed onto the sheet-like tray member 12, as opposed to a bowl, a dog is forced to utilize a larger surface area to effectively “chase” the food and as a result the consumption rate of food and the tendency to gulp is further minimized. In addition, the height of the tray member 12 further reduces stress to the neck and back areas.

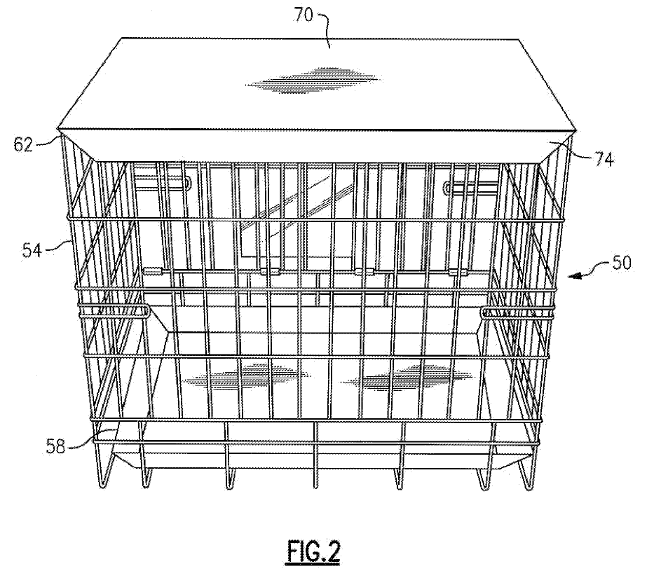

Referring to FIG. 2, a separate variation is herein described with regard to a dog kennel. A typical square or rectangular dog kennel 50 is shown that is defined by a mesh-like cage including a set of side walls 54, a top wall 62 and a bottom wall or surface 66, respectively, therein defining an enclosure. Each of the side walls 54, door 58 and the top wall 62 minimally are made from a galvanized steel or other similar material wherein a door 58 is further provided in one of the sidewalls 54 to permit ingress and egress relative to the enclosure. Specific details relating to kennel construction, per se’, are known in the field such as described, for example, in U.S. Pat. No. 6,553,940, and do not form an essential part of the present invention. Moreover and though a square or rectangular shaped kennel is illustrated herein other shapes are known to which the present invention is equally applicable.

According to this embodiment, a cover or canopy 70 is provided for covering the top wall 62 of the kennel 50 such as an acrylic or a high density polyethylene, this cover being preferably made from a solid durable plastic molded material although other materials, such as plywood, stainless steel or galvanized sheet metal, can be alternatively be used. The top cover 70 is a continuous flat section that is sized to cover the expanse of the top wall 62 of the kennel 50, the cover further including a peripheral ridge or edge 74 that is configured to slightly overhang onto each or some of the top of the side walls 54 of the kennel 50 in order to provide positive engagement therewith.

The top cover 70, when attached to a kennel 50, provides a stable working surface for the kennel 50, whether the kennel is in use or is in storage. For example, a dog (not shown) could be groomed on top of the cover 70 or the cover could be used as a working surface or permit items to be stored thereupon, without fear of having items slip into the interstices of the kennel 50. The top cover 70, when attached to a kennel 50, also prevents the items placed or inadvertently dropped on top of the kennel from falling into the kennel, and thus improves the safety and security of the kenneled dog.

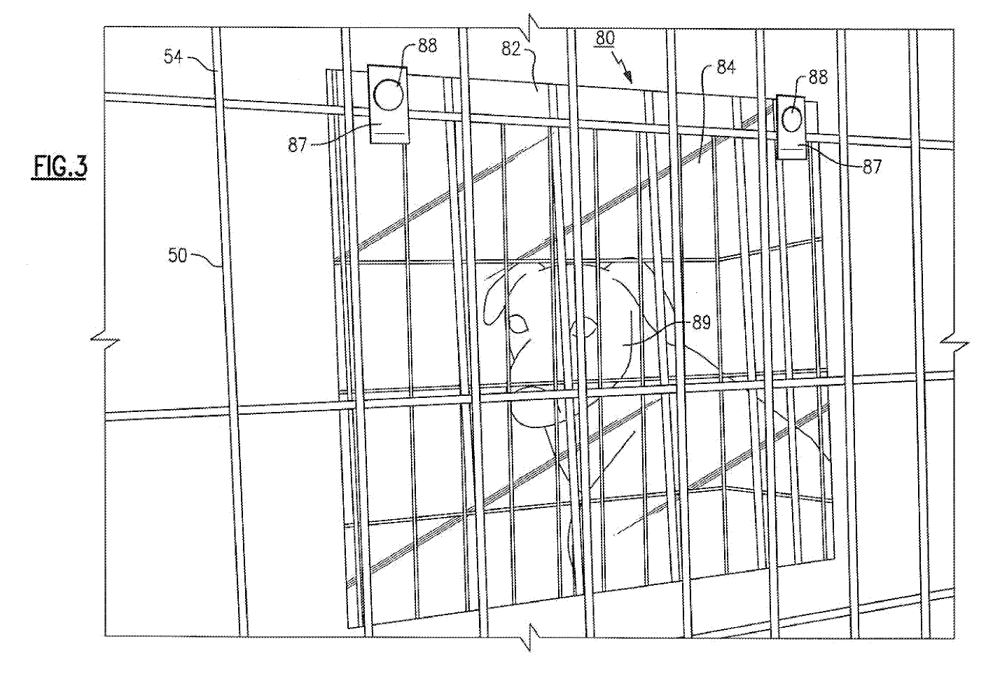

Referring to FIG. 3 and according to another variant of the invention, at least one of the side walls 54 of the kennel 50 can support a device 80 attached thereto. The device 80 is defined by a frame 82 that supports a reflective or mirrored surface 84. The device 80 is attached to the exterior of the side wall 54 of the kennel 50 and more specifically to the outside of a horizontally extending portion of steel wire mesh used therein, using a set of clips and fasteners 87, 88, or other suitable hooking or securing means, wherein the reflective surface 84, once mounted, is oriented inwardly (i.e., toward the inside of the kennel 50) when the device is attached to the outside of the kennel frame. Preferably, the mirrored surface 84 is made from pleixmirror and not glass in order to eliminate any risk of injury to the dog caused by broken glass. The exterior of the frame according to this embodiment further includes a rubberized coating or layer to prevent the occurrence of sharp edges. The mesh-like structure of the kennel 50 permits the dog to see its reflection 89 in the mirrored surface 84 and consequently be calmed, for example, by believing another dog is present. As such, separation anxiety or other similar afflictions can be quelled, thereby calming the dog while in the kennel, such as at night or during storms, for example, and reducing anxiety levels. Attaching the reflective surface 84 to the outside of a kennel side wall improves the safety and security for both the dog trainer and the kenneled dog.

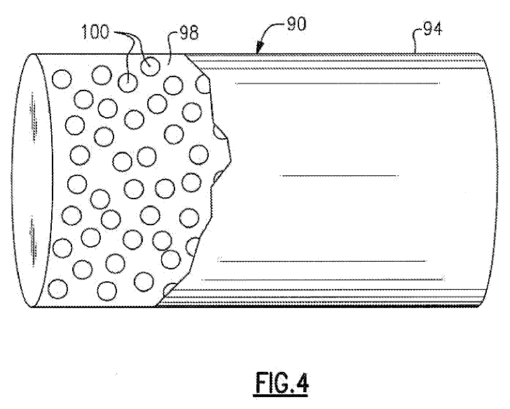

Referring to FIG. 4 and according to yet another embodiment of the invention, there is disclosed a training device 90 including a portable (e.g. hand-held) canister 94 or similar enclosed container that can be hand-held. The container 90 can be made from any durable material, such as aluminum or plastic. According to this specific embodiment, the container 94 is cylindrical in shape and is defined by at least a partially hollow interior 98. A quantity of particulate material 100, such as stones, marbles, or other material, is added to the interior 98 of the container, wherein the material will cause a loud audible sound when the container 94 is agitated or shaken by a user. It will be readily apparent that the container can assume a variety of shapes. The container 90 can include a lid, enabling the device to be reopened for purposes of adding or removing material, if needed.

In use, this training device 90 can be shaken or otherwise agitated, in order to create a loud audible sound. Over time, a dog (not shown) becomes accustomed to the sound that is made by the herein described training device 80, as well as visually to the device itself as it is being used. The sound emanating from the device 90 will divert the dog's attention, for example, from barking, from running towards a door to entering persons, from running out of the house or an area, such as into a street, or from other forms of unwanted or undesired activity. The device is particularly effective with aggressive dogs, but can be used for training in general.

While the present invention has been particularly shown and described with reference to the preferred mode as illustrated in the drawings, it will be understood by one skilled in the art that various changes in detail may be effected therein without departing from the spirit and scope of the invention.

We claim:

1. A dog training device attachable to a kennel, said kennel including at least one side wall, said device comprising:
a reflective surface manufactured from a plastic material; and
a supporting frame adapted to detachably attach to an exterior surface of said side wall;
wherein said supporting frame is configured to support said reflective surface so that said reflective surface faces an interior of said kennel.

2. The device of claim 1, wherein said kennel includes a plurality of side walls, a top wall and a bottom wall.

3. The device of claim 1, wherein said reflective surface is manufactured from pleximirror.

4. The device of claim 1, wherein said supporting frame is adapted to detachably attach to said exterior surface of said side wall using at least one of: one or more clips, one or more fasteners.

5. The device of claim 1, wherein said supporting frame includes a rubberized coating, said rubberized coating adapted to prevent occurrences of sharp edges.

6. A method of training a dog, said method comprising the steps of:
enclosing said dog in a kennel having at least one side wall; and
attaching a supporting frame to an exterior surface of said side wall, said frame supporting a reflective surface so that said reflective surface faces an interior of said kennel;
wherein said reflective surface is provided by a mirror manufactured from a plastic material.

7. The method of claim 6, wherein said kennel is provided by a mesh-like cage.

8. The method of claim 6, wherein said reflective surface is manufactured from pleximirror.

9. The method of claim 6, wherein said step of attaching a supporting frame is performed using at least one of: one or more clips, one or more fasteners.

10. The method of claim 6, wherein said supporting frame includes a rubberized coating, said rubberized coating adapted to prevent occurrences of sharp edges.

11. A device for covering a top wall of a kennel, said kennel including at least one side wall, said device comprising:
a flat sheet made of a durable sheet material;
a peripheral ridge configured to overhang onto a top of said side wall in order to provide an engagement with said at least one side wall.

12. The device of claim 11, wherein said kennel is provided by a mesh-like cage.

13. The device of claim 11, wherein said sheet material is selected from the group consisting of: a plastic material, a plywood, stainless steel ane a galvanized sheet material.

14. The device of claim 11, wherein said flat sheet has a rectangular form.

15. The device of claim 11, wherein said flat sheet forms a working surface on which to groom a dog.
